(19) United States
(12) Patent Application Publication
(10) Pub. No.: US 2024/0339799 A1
(43) Pub. Date: Oct. 10, 2024

(54) A Narrow-band, Low-noise Raman Fiber Laser with A Random Fiber Laser Pump

(71) Applicant: Sichuan Guangsheng IOT Technology Co., Ltd., Chengdu High-tech Zone (West District) (CN)

(72) Inventors: YUNJIANG RAO, Chengdu High-tech Zone (West District) (CN); BING HAN, Chengdu High-tech Zone (West District) (CN); HAN WU, Chengdu High-tech Zone (West District) (CN)

(21) Appl. No.: 18/748,327

(22) Filed: Jun. 20, 2024

Related U.S. Application Data
(63) Continuation of application No. 17/105,527, filed on Nov. 26, 2020.

(51) Int. Cl. H01S 3/094; H01S 3/16; H01S 3/30

(52) U.S. Cl. CPC H01S 3/094046; H01S 3/094065; H01S 3/1618; H01S 3/302

(57) ABSTRACT

The present invention discloses a narrow-band, low-noise Raman fiber laser with a random fiber laser pump, pertaining to the technical field of fiber lasers and comprising an ytterbium-doped random fiber laser for producing ytterbium-doped random fiber lasing as the pump of a cascaded Raman random laser; the ytterbium-doped random fiber laser consists of a pump light source, a pump combiner, an ytterbium-doped fiber and a single-mode fiber connected in sequence, as well as a first narrow-band reflector connected to the signal end of the pump combiner. Ytterbium-doped random fiber lasing as the pump of the pump light source disclosed in the present invention is produced by an ytterbium-doped random fiber laser consisting of a narrow-band point reflector, an ytterbium-doped fiber, and a single-mode fiber and further serves as the pump of a Raman light source to achieve random laser output. The Raman fiber laser with a random fiber laser pump provided by the present invention is significantly better in time-domain stability and relative intensity noise than conventional Raman fiber lasers owing to the application of ytterbium-doped random fiber lasing with modeless spectrum as the pump.

### CROSS REFERENCE TO RELATED APPLICATION

This application is a continuation of U.S. patent application Ser. No. 17/105,527, filed on Nov. 26, 2020, and the entire contents of which are incorporated herein by reference.

### TECHNICAL FIELD

The present invention relates to the technical field of fiber lasers, and specifically, to a narrow-band, low-noise Raman fiber laser with a random fiber laser pump.

### BACKGROUND ART

Conventional Raman fiber lasers consist of a pump source, a resonant cavity, and a gain fiber, and their output wavelength and longitudinal spectrum mode spacing are dependent on the resonant cavity. Such lasers can be used as the pump source for distributed Raman amplification and have been widely applied for fiber communications and sensing. Due to spectrum mode competition, however, when used as the pump source for distributed Raman amplification in long-distance fiber communications and fiber sensing systems, Raman fiber lasers are limited in time-domain stability of laser output and unable to output narrow-band, low-noise, time-domain stable Raman pump light because their relative intensity noise will transfer to the signal light and reduce system performance.

Unlike conventional Raman fiber lasers, random fiber lasers use Raman gain and distributed Rayleigh backscattering feedback in the fiber to achieve laser excitation, and thus have no fixed resonant cavity, low spatial coherence, and modeless spectrum and are simple in construction and flexible in output wavelength tuning. The existing Raman pump light source based on random fiber lasers, however, is mostly realized by single-mode fibers pumped by ytterbium-doped fiber lasers based on a fixed resonant cavity. Its spectrum thus has a resonant peak corresponding to the cavity length of the ytterbium-doped fiber laser, and problems resulting from spectrum mode competition still remain, including great fluctuations in laser output intensity and poor time-domain stability. Secondly, due to the prevalence of self-pulsing and self-mode locking phenomena causing great fluctuations in the output intensity, conventional ytterbium-doped fiber lasers generate a large relative intensity noise, which in turn leads to poor time-domain stability of the Raman pump light output. Furthermore, it provides point feedback through a broad-band reflector for various orders of Stokes light generated in the single-mode fiber, making it difficult to achieve narrow-band laser excitation. The Ytterbium-doped fiber laser of patent No. CN106299988A, titled “A Cascaded Output Fiber Raman Random Laser” for an intention comprises a pump source, an ytterbium-doped fiber, and a resonant cavity consisting of a pair of fiber gratings with high and low reflectivity and generates fiber laser. Due to the resonant cavity, however, the spectrum of its laser output has periodic frequency intervals corresponding to the cavity length, relative intensity noise is great, and the time-domain stability is poor. Further, since the output terminal of the pump combiner in this technical solution is directly connected to the broad-band reflector, even if the fiber grating with low reflectivity is removed from the technical solution of this invention patent, a multi-wavelength laser will be produced in the gain wavelength range of the ytterbium-doped fiber due to the combined effect of the broad-band reflector and the back Rayleigh scattering in the single-mode fiber, and the gain competition of the multi-wavelength laser will also lead to a reduction in the time-domain stability. Still further, the laser comprises connected in sequence a pump module, a pump combiner, an ytterbium-doped fiber laser, and a single-mode fiber, and the signal end of the pump combiner is connected to a broad-band reflector, through which point feedback is provided for the various orders of Stokes light generated in the single-mode fiber, making narrow-band laser excitation unachievable. In summary, the existing technical solution is still unable to output narrow-band, low-noise, time-domain stable Raman pump light.

### SUMMARY OF THE INVENTION

The present invention seeks to overcome such problems with the existing laser as the intense spectrum mode competition in laser output, high relative intensity noise, and poor time-domain stability, and to provide a narrow-band, low-noise Raman fiber laser with a random fiber laser pump.

This purpose is achieved by a narrow-band, low-noise Raman fiber laser with a random fiber laser pump comprising an ytterbium-doped random fiber laser for producing ytterbium-doped random fiber lasing as the pump of a cascaded narrow-band Raman random laser; said ytterbium-doped random fiber laser consists of a pump light source, a pump combiner, a ytterbium-doped fiber and a single-mode fiber connected in sequence, as well as a first narrow-band reflector connected to the signal end of the pump combiner.

As an option, the output terminal of the ytterbium-doped random fiber laser is connected with a second narrow-band reflector with a plurality of different central wavelengths.

As an option, the central wavelengths of said second narrow-band reflector respectively correspond to wavelengths of Stokes light at various stages.

As an option, said first narrow-band reflector and/or second narrow-band reflector has an end face reflectivity smaller than 10⁻⁵.

As an option, said first narrow-band reflector has a central wavelength range of 1,040 nm-1,090 nm.

As an option, said pump light source has a central wavelength of 915 nm or 976 nm.

As an option, said ytterbium-doped fiber is a double-clad ytterbium-doped fiber.

As an option, said single-mode fiber has a length range of 100 m-200 km.

As an option, said single-mode fiber has a specifically angled end face.

As an option, the output wavelength of said narrow-band Raman fiber laser with a random fiber laser pump is tuned by adjusting the operating wavelength of the first narrow-band reflector or the length of the single-mode fiber; the output power of the narrow-band Raman fiber laser with a random fiber laser pump is regulated by adjusting the output power of the pump light source or the length of the single-mode fiber.

It is to be further understood that the technical features corresponding to each of the above-mentioned options may be combined or replaced with each other to form a new technical solution.

Compared with the prior art, the invention has the following beneficial effects:

(1) The Raman fiber laser with a random fiber laser pump disclosed in the present invention uses ytterbium-doped random fiber lasing as the pump. Ytterbium-doped random fiber lasing as the pump of the pump light source is produced by an ytterbium-doped random fiber laser consisting of a narrow-band point reflector, an ytterbium-doped fiber, and a single-mode fiber and further serves as the pump of a Raman light source to achieve random laser output. The Raman fiber laser with a random fiber laser pump provided by the present invention is significantly better in time-domain stability and relative intensity noise than conventional Raman fiber lasers owing to the application of ytterbium-doped random fiber lasing with modeless spectrum as the pump.
(2) The output terminal of the ytterbium-doped random fiber laser disclosed in the present invention is connected with a second narrow-band reflector with a plurality of different central wavelengths to provide forward feedback for random fiber lasers of each order, which, in combination with the random Rayleigh distributed feedback and Raman gain in the single-mode fiber, contributes to a highly stable, modeless spectrum, narrow-band, low-noise Raman pump. High power Raman laser output can thus be achieved without a multistage master oscillation power amplification system, with flexible and adjustable output power and laser wavelength. The ytterbium-doped random fiber laser is expected to replace the conventional Raman pump in long-distance optical transmission systems and improve system performance.
(3) The first narrow-band reflector of the invention has a central wavelength ranging from 1,040 nm to 1,090 nm, which can be changed to tune the wavelength of the output Raman pumped light.
(4) The reflectivity of the end faces at the tail ends of the first and second narrow-band reflectors is less than 10, which is used for separating light of other wavelength within the gain wavelength range of the ytterbium-doped fiber to realize the single-wavelength stable output of ytterbium-doped random fiber lasing.
(5) The length range of the single-mode fiber is 100 m-200 km, and the wavelength and power output of output Raman pumped light can be adjusted by changing the length of the single-mode fiber.

### INSTRUCTION WITH FIGURES

The preferred embodiments of the present invention will be further described in detail with reference to the figures which are parts of this application and will help further understand on this application. In these figures, same reference marks are indicating the same or similar parts. The illustrative embodiments and corresponding descriptions are not improper limitations but for explaining this application.

FIG. 1 is a system chart of Embodiment 1;

FIG. 2 is a power distribution simulation diagram of Embodiment's narrow-band Raman pump light source of each order in a single-mode fiber;

FIG. 3 is an output power simulation diagram of Embodiment's narrow-band Raman pump light source of each order.

In the figure: Pump light source 1, pump combiner 2, ytterbium-doped fiber 3, single-mode fiber 4, narrow-band point reflector module 5.

### DETAILED DESCRIPTION OF THE PREFERRED EMBODIMENTS

The following is a clear and complete description of the technical schemes in the invention along with the drawings. Obviously, the embodiments are only some of rather than all of the embodiments of the invention. All other embodiments obtained by persons of ordinary skill in the art based on the embodiments of the invention without creative efforts shall fall within the protection scope of the invention.

It needs to be noted that the directions or position relationships such as “central”, “upper”, “lower”, “left”, “right”, “vertical”, “horizontal”, “inside” and “outside” in the description of the invention are based on those on drawings, and are used only for facilitating the description of the invention and for simplified description, not for indicating or implying that the target devices or components must have a special direction and be structured and operated at the special direction, thereby they cannot be understood as the restrictions to the invention. Moreover, the words “first” and “second” are used only for description, and cannot be understood as indication or implying of relative importance.

It needs to be noted in the description of the invention that unless otherwise specified or restricted, the words of “installation”, “interconnection” and “connection” shall be understood as a general sense. For example, the connection can be fixed connection, removable connection, integrated connection, mechanical connection, electrical connection, direct connection, indirect connection through intermediate media or connection between two components. Persons of ordinary skill in the art of the invention can understand the specific meanings of the terms above in the invention as the case may be.

Moreover, the technical characteristics involved in different embodiments of the invention as described below can be combined together provided there is no discrepancy among them.

### Embodiment 1

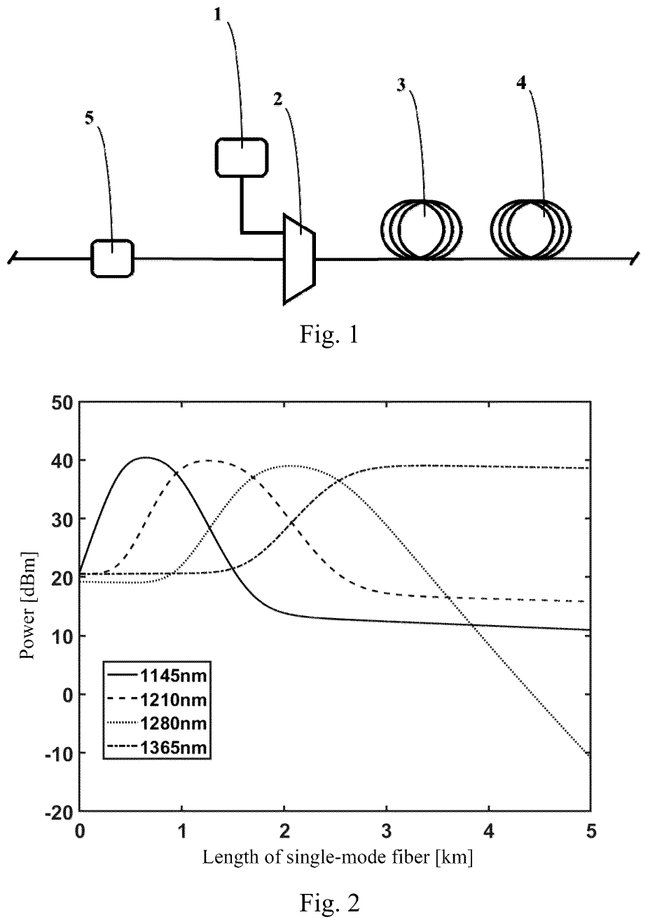

As shown in FIG. 1, in Embodiment 1, the narrow-band, low-noise Raman fiber laser with a random fiber laser pump includes an ytterbium-doped random fiber laser for generating an ytterbium-doped random fiber laser as a cascaded narrow-band Raman random laser pump; ytterbium-doped random fiber laser consists of pump light source 1, pump combiner 2, ytterbium-doped fiber 3, single-mode fiber 4 connected in sequence and a first narrow-band reflector connected to the signal end of pump combiner 2, with simple and compact structure. Through the extremely weak Rayleigh backscattering light in the single-mode fiber 4 as feedback, ytterbium-doped random fiber lasing is generated without fixed resonant cavity, so there is no periodic interval of frequency spectrum corresponding to the fixed resonant cavity length, showing the characteristics of modeless spectrum and high time-domain stability. When the ytterbium-doped random fiber lasing with modeless spectrum is used as the pump of Raman light source, the generated Raman pump light source based on random fiber laser also shows no longitudinal mode but has good time-domain stability, which is more suitable for low-noise, high-performance and long-distance optical fiber communication and optical fiber sensing systems. Specifically, the output end of pump light source 1 is connected with the pump end of pump combiner 2 whose output end is connected with one end of ytterbium-doped fiber 3. The other end of ytterbium-doped fiber 3 is connected with one end of single-mode fiber 4, and the signal end of pump combiner 2 is connected with one end of first narrow-band reflector.

Furthermore, the output end of ytterbium-doped random fiber laser is connected with multiple second narrow-band reflectors with different central wavelengths, that is, the signal end of the pump combiner 2 is connected with one end of the second narrow-band reflector, which is used to provide forward feedback for each order of narrow-band random fiber laser. In combination with the random Rayleigh distributed feedback and Raman gain in the single-mode fiber, it contributes to a highly stable, modeless, narrow-band, low-noise Raman pump. High power Raman laser output can thus be achieved without a multistage master oscillation power amplification system, with flexible and adjustable output power and laser wavelength. The ytterbium-doped random fiber laser is expected to replace the conventional Raman pump in long-distance optical transmission systems and improve system performance.

Furthermore, the central wavelengths of said second narrow-band reflector respectively correspond to wavelengths of Stokes light at various stages, thus providing forward feedback for random fiber lasers of each order and realizing the output of the narrow-band and low-noise cascaded Raman light source. As an embodiment, the center wavelengths of the second narrow-band reflector are 1,145 nm, 1,210 nm, 1,280 nm and 1,365 nm respectively, providing feedback conditions for long-wavelength cascaded Raman laser excitation.

Further, the first narrow-band reflector and the second narrow-band reflector constitute a narrow-band reflector module 5, wherein the end reflectivity of the second narrow-band reflector and/or the tail end of the first narrow-band reflector is less than 10⁻⁵. As an embodiment, the reflectivity of the end face of the narrow-band reflector module 5 is less than 10⁻⁵, which is used for separating light of other wavelength within the gain wavelength range of the ytterbium-doped fiber to realize the single-wavelength stable output of ytterbium-doped random fiber lasing.

Further, the first narrow-band reflector of the invention has a central wavelength ranging from 1,040 nm to 1,090 nm, which can be changed to tune the wavelength of the output Raman pumped light. As a specific embodiment, the narrow-band point reflector is a fiber Bragg grating (FBG) with a center wavelength of 1,090 nm and a reflectivity of 99.5%, providing front-end point feedback for ytterbium-doped random fiber lasing.

Further, the center wavelength of the pump light source 1 is 915 nm or 976 nm with unlimited output power. As a specific embodiment, the central wavelength of the pump light source 1 is 976 nm with a specific output power of 15 W. The output power of the output Raman pumped light can be adjusted by changing the output power of the pump light source 1.

Further, the ytterbium-doped fiber 3 is a double-clad one lengthening from 1 m to 50 m to withstand high-power laser. As a specific embodiment, the ytterbium-doped fiber 3 is 5 m. More specifically, the tail end of the narrow-band reflector module 5 is cut at an angle of 8°, so as to reduce Fresnel reflection at the port and ensure the single-wavelength output stability of random laser light from the ytterbium-doped fiber 3.

Furthermore, the length of the single-mode fiber 4 ranges from 100 m-200 km, and the wavelength and power of the output Raman pumped light can be adjusted by changing the length of the single-mode fiber 4. As a specific embodiment, the single-mode fiber 4 is 5 km.

Furthermore, the tail end of the single-mode fiber 4 is an inclined end face with a reflectivity less than 10′, as an output port of Raman pump light and outputs stable, narrow-band, low-noise Raman fiber laser with a random fiber laser pump.

Further, the output wavelength (wavelength of random fiber laser Raman pumped light) of narrow-band, low-noise Raman fiber laser with a random fiber laser pump can be adjusted by changing the working wavelength of the first narrow-band reflector or the length of the single-mode fiber 4. The output power of the narrow-band, low-noise Raman fiber laser with a random fiber laser pump can be adjusted by adjusting the output power of the pump light source 1 or the length of the single-mode fiber 4.

In order to understand the technical scheme of the present invention better, the specific output process of stable and low-noise random fiber laser Raman pump light will now be explained according to the above specific embodiments:

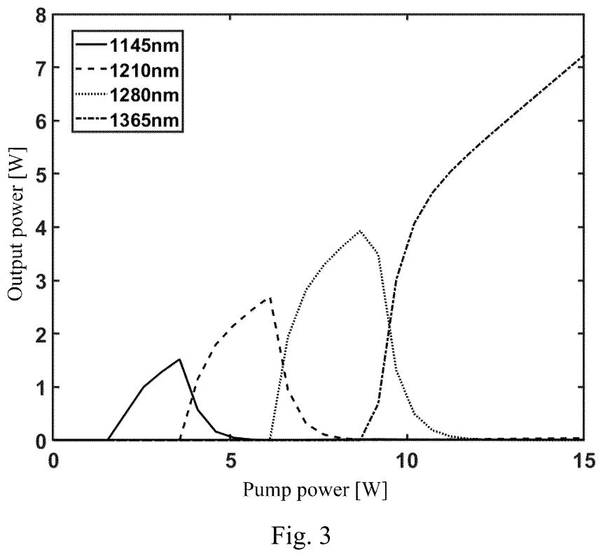

In the stable Raman pump light source of narrow-band random fiber laser, a pump light source 1 with a central wavelength of 976 nm outputs pump light which is injected into a 5 m double-clad ytterbium-doped fiber 3 and a 5 km single-mode fiber 4 through a pump combiner 2, and the single-mode fiber 4 provides random Rayleigh distribution feedback for the ytterbium-doped random fiber lasing; the first narrow-band reflector in the narrow-band point reflector module 5 with a center wavelength of 1,090 nm and a reflectivity of 99.5% provides front-end point feedback for the ytterbium-doped random fiber lasing, and the generated 1,090 nm single-wavelength ytterbium-doped random fiber lasing is injected into the single-mode fiber 4 as a pump of Raman light source. The center wavelengths of the second narrow-band reflectors are respectively 1,145 nm, 1, 210 nm, 1, 280 nm and 1,365 nm, providing front-end feedback for generation of cascaded narrow-band high-order random fiber lasers. Combined with random Rayleigh distribution feedback and Raman gain in single-mode fiber 4, stable narrow-band, low-noise Raman fiber laser with a random fiber laser pump is output from single-mode fiber 4. The power distribution of each order of narrow-band random fiber lasers in 5 km single-mode fiber is shown in FIG. 2, and the output power of each order of narrow-band random fiber lasers is shown in FIG. 3.

The narrow-band, low-noise Raman fiber laser with a random fiber laser pump provided by the invention can be applied to optical fiber communication or optical fiber sensing systems, with better time-domain stability, and can be used as a low-noise pump source for distributed Raman amplification in long-distance optical fiber communication and sensing systems.

### Embodiment 2

The inventive concept of Embodiment 2 is the same as that of Embodiment 1. On the basis of Embodiment 1, the power of pump light source 1 can be reduced to 8 W to realize 1,280 nm narrow-band Raman pump light output.

### Embodiment 3

The inventive concept of Embodiment 3 is the same as that of Embodiment 1. On the basis of Embodiment 1, the length of the single-mode fiber 4 can be reduced to 3 km to realize the higher power of 1, 210 nm narrow-band Raman pump light output.

### Embodiment 4

The inventive concept of Embodiment 4 is the same as that of Embodiment 1. On the basis of Embodiment 1, adjust the center wavelength of the second narrow-band point reflector in the narrow-band reflector module 5 to 1,064 nm and the first narrow-band point reflector to 1,115 nm and 1,175 nm, realizing narrow-band Raman pump light output with wavelengths of 1, 115 nm and 1, 175 nm. It should be noted that Raman pump light with wavelengths of 1,115 nm and 1,175 nm corresponds to the first-order Raman Stokes wavelength and the second-order Stokes light wavelength of 1,064 nm ytterbium-doped random fiber laser respectively.

The above preferred embodiments are detailed descriptions of the present invention, and it cannot be considered that the specific embodiments of the present invention are limited to these descriptions. Ordinary technicians in the technical field of this invention can do some simple deductions and substitutions based on the concept of the present invention, which should be ensured.

1. A narrow-band, low-noise Raman fiber laser with a random fiber laser pump, comprising an ytterbium-doped random fiber laser for producing ytterbium-doped random fiber laser light; said ytterbium-doped random fiber laser comprises a pump light source (1), a pump combiner (2), an ytterbium-doped fiber (3) and a single-mode fiber (4) connected in sequence, as well as a first narrow-band reflector connected to a signal end of the pump combiner (2);
an output wavelength of said narrow-band Raman pump light source based on random fiber laser is tuned by adjusting an operating wavelength of the first narrow-band reflector or a length of the single-mode fiber (4).

2. The narrow-band, low-noise Raman fiber laser with a random fiber laser pump according to claim 1, wherein said first narrow-band reflector has an end face reflectivity smaller than 10⁻⁵.

3. The narrow-band, low-noise Raman fiber laser with a random fiber laser pump according to claim 1, wherein said first narrow-band reflector has a central wavelength range of 1,040_nm-1,090_nm.

4. The narrow-band, low-noise Raman fiber laser with a random fiber laser pump according to claim 1, wherein said pump light source (1) has a central wavelength of 915_nm or 976_nm.

5. The narrow-band, low-noise Raman fiber laser with a random fiber laser pump according to claim 1, wherein said ytterbium-doped fiber (3) is a double-clad ytterbium-doped fiber.

6. The narrow-band, low-noise Raman fiber laser with a random fiber laser pump according to claim 1, wherein said single-mode fiber (4) has a length range of 100_m-200_km.

7. The narrow-band, low-noise Raman fiber laser with a random fiber laser pump according to claim 1, wherein said single-mode fiber (4) has an angled end face.

8. The narrow-band, low-noise Raman fiber laser with a random fiber laser pump according to claim 1, wherein an output power of the narrow-band Raman pump light source based on random fiber laser is regulated by adjusting an output power of the pump light source (1) or the length of the single-mode fiber (4).
